(19) United States
(12) Patent Application Publication
(10) Pub. No.: US 2010/0134028 A1
(43) Pub. Date: Jun. 3, 2010

(54) LIGHT SOURCE

(75) Inventors: Gerlach Corne Pieter Maria Emmen, Eindhoven (NL); Theodorus Maria Hendriks, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,712

(22) PCT Filed: Feb. 17, 2006
(86) PCT No.: PCT/IB2006/050527

§ 371 Date: Aug. 21, 2007

(30) Foreign Application Priority Data
Feb. 25, 2005 (EP) 05101464.5

(51) Int. Cl. H05B 37/02

(52) U.S. Cl. 315/224; 315/291

(57) ABSTRACT

A light source comprises a discharge lamp (LA), a bridge circuit for driving the discharge lamp and a reflector (RE). The bridge circuit comprises a capacitor (C1) coupled between a lamp connection terminal (T3, T4) and an input terminal of the bridge circuit (T1). EMI caused by the discharge lamp is suppressed by connecting a further capacitor (C2) between the lamp connection terminal and the reflector, so that a conductive path exists between the reflector and the bridge input terminal formed by both capacitors.

The invention relates to a light source comprising

a discharge lamp,

a reflector,

a lamp driver circuit for generating lamp current out of a DC supply voltage, equipped with
first and second input terminals for coupling to the poles of a supply voltage source,
first and second lamp connection terminals,
a first chain connecting the first lamp connection terminal to the first input terminal and comprising a first capacitor.

The invention also relates to a lamp driver-reflector combination comprising

a reflector,

a lamp driver circuit for generating lamp current out of a DC supply voltage, equipped with
first and second input terminals for coupling to the poles of a supply voltage source,
first and second lamp connection terminals,
a first chain connecting the first lamp connection terminal to the first input terminal and comprising a first capacitor,

A light source as mentioned in the opening paragraph is known from U.S. Pat. No. 6,486,614 B1. The discharge lamp comprised in such a light source is an HID lamp, since an HID lamp has a very short discharge arc during operation. As a consequence the discharge arc is in first approximation a point light source, so that the spatial distribution of the light can be controlled by the shape and the dimensions of the reflector. A problem associated with such a light source is that the discharge lamp generally causes EMI. To suppress the EMI generated by the light source, the reflector is often connected to ground potential. In the known light source this is done by means of a separate wire. The need for this separate wire (in addition to the wires supplying the discharge lamp) is a strong disadvantage of the known light source.

The invention aims to supply a light source wherein the EMI caused by the light source is effectively suppressed without making use of an additional wire.

A light source as mentioned in the opening paragraph is therefore characterized in that the light source comprises a second chain connecting the reflector and the first lamp connection terminal.

Similarly, a lamp driver-reflector combination as mentioned in the second paragraph is characterized in that the light source comprises a second chain connecting the reflector and the first lamp connection terminal.

In a light source according to the invention, the first and second chain together provide an electrically conductive connection between the reflector and the first input terminal. By means of this electrically conductive connection EMI is effectively suppressed, while a separate wire for connecting the reflector to ground potential is not needed. Since the first lamp connection terminal and the reflector are very close to each other, the second chain can be very short.

The second chain can be formed by means of a direct conductive connection of the reflector to the first lamp terminal. Alternatively the second chain may comprise a second capacitor, to prevent DC currents from flowing between the reflector and the discharge lamp.

Good results have been obtained for a light source according to the invention, wherein the lamp driver circuit comprises a half bridge circuit equipped with
a series arrangement of two switching elements coupled between the input terminals,
a load chain shunting one of the switching elements and comprising a series arrangement of the lamp connection terminals and the first capacitor.

The bridge circuit may comprise a third capacitor coupled between the first lamp terminal and the second input terminal. In case of such a bridge circuit the reflector is conductively connected to both the first and the second input terminal. The EMI suppression is thereby increased.

Good results have also been obtained for a light source according to the invention, wherein the lamp driver circuit comprises a full bridge circuit equipped with
a first series arrangement of two switching elements coupled between the input terminals,
a second series arrangement of two switching elements coupled between the input terminals,
a load chain connecting a common terminal of the switching elements in the first series arrangement with a common terminal of the switching elements in the second series arrangement and comprising the lamp connection terminals.

Embodiments of the invention will be explained making reference to a drawing. In the drawing

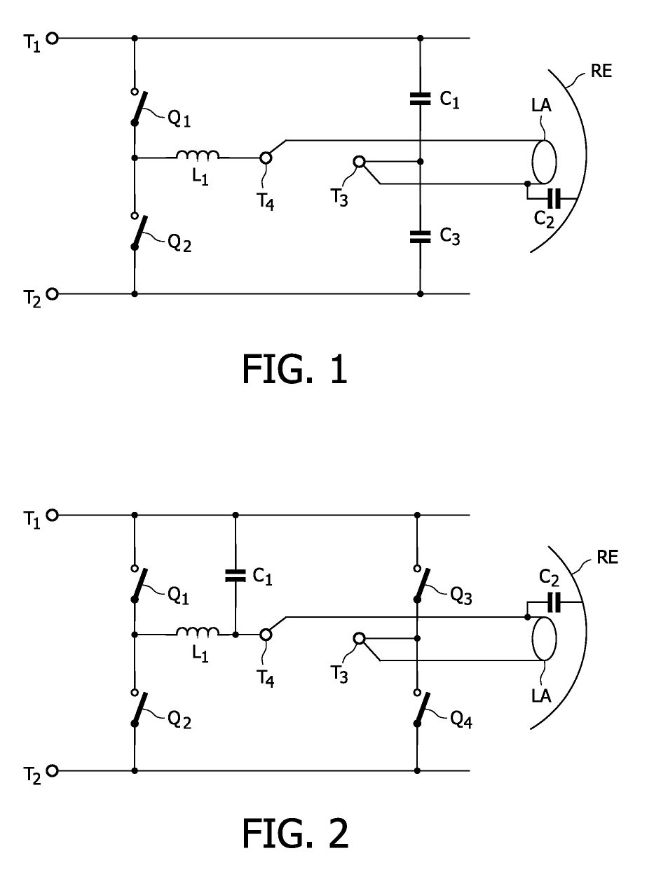

FIG. 1 shows a schematic representation of an embodiment of a light source according to the invention, comprising a lamp driver equipped with a half bridge circuit, and

FIG. 2 shows a schematic representation of an embodiment of a light source according to the invention, comprising a lamp driver equipped with a full bridge circuit.

In FIG. 1, T1 and T2 are first and second input terminals for coupling to the poles of a supply voltage source. Input terminals T1 and T2 are connected by means of a series arrangement of switching elements Q1 and Q2 and by means of a series arrangement of first and third capacitors C1 and C3 respectively. A common terminal of switching elements Q1 and Q2 is connected to a common terminal of first and third capacitors C1 and C3 by means of a series arrangement of an inductor L, lamp connection terminal T4, lamp LA, and lamp connection terminal T3. Inductor L, lamp connection terminal T3, lamp LA, lamp connection terminal T4 and first capacitor C1 together form a load chain shunting switching element Q1. RE is a reflector and C2 is a second capacitor connecting the reflector RE to the lamp connection terminal T3. In the embodiment shown in FIG. 1, lamp connection terminal T3 forms the first lamp connection terminal and lamp connection terminal T4 the second lamp connection terminal. The second capacitor C2 forms a second chain connecting the reflector and the first lamp connection terminal. First capacitor C1 forms a first chain connecting the first lamp connection terminal T3 to the first input terminal T1. All the components of the light source shown in FIG. 1 apart from reflector RE, second capacitor C2 and the discharge lamp LA together form a driver circuit that is a half bridge circuit.

The operation of the light source shown in FIG. 1 is as follows.

During stationary operation, a control circuit (not shown in FIG. 1) renders the switching elements Q1 and Q2 alternatingly conductive and non-conductive at a high frequency. In this way a high frequency AC current through the discharge lamp LA is generated. Because of this high frequency AC current, the discharge lamp causes EMI. In the light source shown in FIG. 1, the series arrangement of second capacitor C2 and first capacitor C1, provides a conductive path between the reflector RE and the first input terminal T1, that suppresses the EMI generated by the light source to a large extent. In the light source shown in FIG. 1, a further conductive path exists between the reflector RE and the second input terminal. This second low impedance conductive path is formed by the second capacitor C2 and the third capacitor C3 and suppresses the EMI caused by the reflector RE even further.

It is important to note that when either first capacitor C1 or third capacitor C3 would be removed from the driver circuit, the driver circuit would still operate satisfactorily and EMI suppression would still take place.

It is also important to note that in case capacitor C2 is replaced by a conductive connection of the reflector to the first lamp terminal, effective suppression of EMI still takes place. In other words the second chain may be a simple conductive connection.

In FIG. 2 similar components are labelled with the same reference numerals. The embodiment shown in FIG. 2 differs from the embodiment shown in FIG. 1 in that the series arrangement of first capacitor C1 and third capacitor C3 has been replaced by a series arrangement of a third switching element Q3 and a fourth switching element Q4. First capacitor C1 is now present between lamp connection terminal T4 and first input terminal T1. Also in this embodiment first capacitor C1 forms a first chain connecting the first lamp connection terminal to the first input terminal. In this embodiment lamp connection terminal T4 forms the first lamp connection terminal. Consequently, lamp connection terminal T3 forms the second lamp connection terminal. Second capacitor C2 is connected between lamp connection terminal T4 and reflector RE and forms a second chain connecting the reflector RE and the first lamp connection terminal. All the components of the light source shown in FIG. 2 apart from reflector RE, second capacitor C2 and the discharge lamp LA together form a driver circuit that is a full bridge circuit.

The operation of the light source shown in FIG. 2 is as follows. During stationary operation the light source is alternatingly at a low frequency controlled in a first and a second mode of operation. In the first mode of operation, a control circuit that is not shown in FIG. 2 controls switching elements T2 and T3 in a non-conducting state and switching element T4 in a conducting state. Switching element T1 is rendered alternatingly conductive and non-conductive at a high frequency (for instance in the range 10 kHz-50 kHz) In the second mode of operation, the control circuit controls switching elements T1 and T4 in a non-conducting state and switching element T3 in a conducting state. Switching element T2 is rendered alternatingly conductive and non-conductive at a high frequency. By alternating between the first and second mode of operation a low frequency square wave shaped AC discharge lamp current is generated. The EMI generated by the reflector RE because of this current is suppressed to a substantial extent by the conductive path between the reflector RE and the first input terminal formed by the series arrangement of second capacitor C2 and first capacitor C1.

Also in the embodiment shown in FIG. 2, effective EMI suppression is also realized in case second capacitor C2 is replaced by a conductive connection.

1. A light source comprising
a discharge lamp,
a reflector,
a lamp driver circuit for generating lamp current out of a DC supply voltage, equipped with
first and second input terminals for coupling to the poles of a supply voltage source,
first and second lamp connection terminals,
a first chain connecting the first lamp connection terminal to the first input terminal and comprising a first capacitor, characterized in that the light source comprises a second chain connecting the reflector and the first lamp connection terminal.

2. A light source as claimed in claim 1, wherein the second chain comprises a second capacitor.

3. A light source as claimed in claim 1, wherein the lamp driver circuit comprises a half bridge circuit equipped with
a series arrangement of two switching elements coupled between the input terminals,
a load chain shunting one of the switching elements and comprising a series arrangement of the lamp connection terminals and the first capacitor.

4. A light source as claimed in claim 3, wherein the half bridge circuit comprises a third capacitor coupled between the first lamp terminal and the second input terminal.

5. A light source as claimed in claim 1, wherein the lamp driver circuit comprises a full bridge circuit equipped with
a first series arrangement of two switching elements coupled between the input terminals,
a second series arrangement of two switching elements coupled between the input terminals,
a load chain connecting a common terminal of the switching elements in the first series arrangement with a common terminal of the switching elements in the second series arrangement and comprising the lamp connection terminals.

6. A comprising lamp driver-reflector combination,
a reflector,
a lamp driver circuit for generating lamp current out of a DC supply voltage, equipped with
first and second input terminals for coupling to the poles of a supply voltage source,
first and second lamp connection terminals,
a first chain connecting the first lamp connection terminal to the first input terminal and comprising a first capacitor,
characterized in that the light source comprises a second chain connecting the reflector and the first lamp connection terminal.
